(19) United States
(12) Patent Application Publication
(10) Pub. No.: US 2008/0213736 A1
(43) Pub. Date: Sep. 4, 2008

(54) METHOD AND APPARATUS FOR EMOTIONAL PROFILING

(76) Inventor: Jon Morris, Gainesville, FL (US)

Correspondence Address: LOWRIE, LANDO & ANASTASI, LLP, ONE MAIN STREET, SUITE 1100, CAMBRIDGE, MA, 02142, US

(21) Appl. No.: 11/966,679

(22) Filed: Dec. 28, 2007

Related U.S. Application Data
(60) Provisional application No. 60/882,415, filed on Dec. 28, 2006.

(51) Int. Cl. G09B 19/00

(52) U.S. Cl. 434/236

(57) ABSTRACT

A method for emotional profiling comprises: obtaining, from plural respondents, non-verbal emotional response data, along with verbal responses; grouping the verbal responses according to the non-verbal emotional response data; and reporting the verbal and/or text-based responses by group. An apparatus for emotional profiling comprises: means for obtaining quantitative and/or qualitative emotional response data, along with verbal and/or text-based responses from participants; means for grouping response data and responses according to the quantitative and/or qualitative data; and means for reporting the verbal and/or text-based responses by group.

### RELATED APPLICATIONS

This application claims priority under 35 U.S.C. § 119(e) to U.S. Provisional Application Ser. No. 60/882,415, entitled “Method and Apparatus for Emotional Profiling,” filed on Dec. 28, 2006, which is herein incorporated by reference in its entirety.

### BACKGROUND OF INVENTION

1. Field of Invention

The present invention relates to methods of ascertaining the reaction of a human subject to a stimulus, particularly ascertaining the subject's emotional response to the stimulus.

2. Discussion of Related Art

A great deal of work has been done in the field of ascertaining responses, especially emotional responses of human subjects to various stimuli. Describing emotions and emotional response is important to understanding the behavior of human subjects in connection with many academic and scientific fields. Albert Mehrabian and James A. Russell have worked extensively in the field, developing, for example, a three-dimensional model of human emotion. Their model includes a Pleasure axis, an Arousal axis and a Dominance axis, hence going by the name PAD.

### SUMMARY OF INVENTION

According to some aspects, emotional profiling methods include obtaining quantitative and/or qualitative emotional response data, along with verbal and/or text-based responses from participants; grouping response data and responses according to the quantitative and/or qualitative data; and reporting the verbal and/or text-based responses by group. The quantitative and/or qualitative data may be evaluated and grouped numerically or by other suitable methods. Groups may be as narrow as each individual possible quantitative and/or qualitative data point, or may be the result of any suitable aggregating function, such as averaging, set groupings, etc.

An aspect includes a method for emotional profiling, comprising: obtaining, from plural respondents, non-verbal emotional response data, along with verbal responses; grouping the verbal responses according to the non-verbal emotional response data; and reporting the verbal responses by group. In variations on this aspect, obtaining further comprises: measuring emotional response using a multi-dimensional questionnaire, for example using pictorial indicia of response on each dimension, measuring emotional response using an MRI scan, using a CAT scan, using a galvanic skin monitor, using a heart rate monitor or using a cranial sensor. In other variations, grouping further comprises: representing graphically in a multi-dimensional space a correspondence between each verbal response and a portion of the multi-dimensional space corresponding to a non-verbal emotional response datum. In yet other variations, the multi-dimensional space is defined by Pleasure, Arousal and Dominance axes.

Another aspect includes an apparatus for emotional profiling, comprising: means for obtaining, from plural respondents, non-verbal emotional response data, along with verbal responses; means for grouping the verbal responses according to the non-verbal emotional response data; and means for reporting the verbal responses by group. In variations on this aspect, the means for obtaining further comprises: means for measuring emotional response using a multi-dimensional questionnaire, for example using pictorial indicia of response on each dimension, means for measuring emotional response using an MRI scan, using a CAT scan, using a galvanic skin monitor, using a heart rate monitor or using a cranial sensor. In other variations, means for grouping further comprises: means for representing graphically in a multi-dimensional space a correspondence between each verbal response and a portion of the multi-dimensional space corresponding to a non-verbal emotional response datum. In yet other variations, the multi-dimensional space is defined by Pleasure, Arousal and Dominance axes.

### BRIEF DESCRIPTION OF DRAWINGS

In the drawings, each identical or nearly identical component or act that is illustrated in various figures is represented by a like numeral. For purposes of clarity, not every component may be labeled in every drawing. In the drawings:

FIG. 1 is a flow chart showing an aspect of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Emotional profiling includes combining two kinds of emotional information into a representation by which the emotional response of a subject, for example a human subject, is better understood. One kind of emotional information is verbal, that is, information the subject expresses in or relates to words; the other kind of emotional information is non-verbal, that is information that the subject expresses through behavior, pictures, facial expression, brain activity, other physiological changes, etc. The non-verbal information may later be associated with words that are understood to correspond to particular non-verbal information.

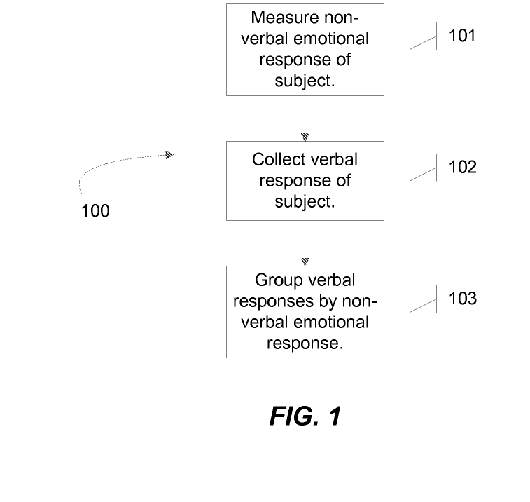

FIG. 1 shows the basic process, 100, of the exemplary embodiment. In steps 101 and 102, the non-verbal and verbal responses of a subject are measured and collected. In step 103, the verbal responses are grouped by their corresponding non-verbal response. The basic process, 100, may be carried out before, during and/or after exposing the subject to a stimulus.

Emotional response data is gathered by any one or more of several methods. Using one group of methods, subjects can self-report their emotional response. Self-reported emotional response scores can be produced using questionnaires, etc., whether paper-based, interview-based or collected by machine. One group of popular self-reporting questionnaires, implemented as paper-based, interview-based and machine-based implementations, employs a self-assessment manikin such as that attributed to Mehrabian or others. Alternatively, a device sensitive to emotional response can provide the emotional response data. For example, emotional response can be measured by observing physiological changes using devices such as functional Magneto-Resonant Imaging (fMRI), Magneto-Resonant Imaging (MRI), Positron-Emission Tomography (PET) scans EEG, EKG or other neural sensors or measures. Emotional response can also be measured by observing behaviors such as changing facial expressions, using human observers or machine-based observers. It is now understood that using a multi-dimensional model such as the PAD emotional model, an emotional state defined in part by a value along one axis of the model will correspond to a detectable physiological change measured using the devices or techniques indicated. Thus, using one of the devices or techniques indicated, a researcher can map a subject's physiological changes in response to a stimulus to a point in the space defined by, for example, the PAD model. Self-report scores from well-designed questionnaires and the like readily map to the three-dimensional PAD model.

In practice, a subject is exposed to a stimulus, for example an advertisement. Before, during and/or after such exposure, the emotional response of the subject is measured using a tool such as a paper or machine-generated graphical or verbal questionnaire, or one of the devices mentioned above. In addition, the subject is presented with a verbal survey, either orally, on paper or by machine.

Subjects' oral or written, verbal (i.e., using words) responses to stimuli, surveys or questionnaires are keyed to the emotional response data for each subject. The data may, if desired, also be keyed to personally identifying information.

The combination (with or without personally identifying information), in any manner, of subjects' individual or aggregate emotional response data with corresponding oral or written verbal responses is known as an Emotional Profile. The Emotional Profile can be presented to show each data point with its corresponding verbal statements in raw form, or can be presented to show emotional response data clustered into groups together with corresponding verbatim statements. For example, a three dimensional graph, in the case of the PAD model, can display detected emotional responses keyed to corresponding verbal responses using footnotes, hyperlinks or any other suitable technique. Alternatively, non-verbal emotional responses can be tabularized, with verbal responses simply listed together with the non-verbal emotional response to which they correspond.

Methods according to aspects of embodiments of the invention may be used in any suitable discipline, for example, psychology, medicine, marketing, or communications, or for any other suitable use.

The means for practicing the invention include any suitable manual and computer-based system. An example of an Emotional Profile produced by a method embodying various aspects of the invention follows, but this is only an example and not intended to limit the subject matter contemplated as within the scope of the invention.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for emotional profiling, comprising:
obtaining, from plural respondents, non-verbal emotional response data, along with verbal responses;
grouping the verbal responses according to the non-verbal emotional response data; and
reporting the verbal responses by group.

2. The method of claim 1, wherein obtaining further comprises:
measuring emotional response using a multi-dimensional questionnaire.

3. The method of claim 2, wherein the questionnaire measures response using pictorial indicia of response on each dimension.

4. The method of claim 1, wherein obtaining further comprises:
measuring emotional response using an MRI scan.

5. The method of claim 1, wherein obtaining further comprises:
measuring emotional response using a CAT scan.

6. The method of claim 1, wherein obtaining further comprises:
measuring emotional response using a galvanic skin monitor.

7. The method of claim 1, wherein obtaining further comprises:
measuring emotional response using a heart rate monitor.

8. The method of claim 1, wherein obtaining further comprises:
measuring emotional response using a cranial sensor.

9. The method of claim 1, wherein grouping further comprises:
representing graphically in a multi-dimensional space a correspondence between each verbal response and a portion of the multi-dimensional space corresponding to a non-verbal emotional response datum.

10. The method of claim 9, wherein the multi-dimensional space is defined by Pleasure, Arousal and Dominance axes.

11. Apparatus for emotional profiling, comprising:
means for obtaining, from plural respondents, non-verbal emotional response data, along with verbal responses;
means for grouping the verbal responses according to the non-verbal emotional response data; and
means for reporting the verbal responses by group.

12. Apparatus according to claim 11, wherein obtaining further comprises:
means for measuring emotional response using a multi-dimensional questionnaire.

13. Apparatus according to claim 12, wherein the questionnaire measures response using pictorial indicia of response on each dimension.

14. Apparatus according to claim 11, wherein obtaining further comprises:
means for measuring emotional response using an MRI scan.

15. Apparatus according to claim 11, wherein obtaining further comprises:
means for measuring emotional response using a CAT scan.

16. Apparatus according to claim 11, wherein obtaining further comprises:
means for measuring emotional response using a galvanic skin monitor.

17. Apparatus according to claim 11, wherein obtaining further comprises:
means for measuring emotional response using a heart rate monitor.

18. Apparatus according to claim 11, wherein obtaining further comprises:
means for measuring emotional response using a cranial sensor.

19. Apparatus according to claim 11, wherein grouping further comprises:
means for representing graphically in a multi-dimensional space a correspondence between each verbal response and a portion of the multi-dimensional space corresponding to a non-verbal emotional response datum.

20. Apparatus according to claim 19, wherein the multi-dimensional space is defined by Pleasure, Arousal and Dominance axes.
